(19) United States
(12) Patent Application Publication
(10) Pub. No.: US 2025/0036507 A1
(43) Pub. Date: Jan. 30, 2025

(54) MODIFYING OPERATIONS OF SYSTEMS BASED ON ERROR DETECTION

(71) Applicant: NVIDIA Corporation, Santa Clara, CA (US)

(72) Inventors: Vito MAGNANIMO, Munchen (DE); Daniel PERRIN, Fort Collins, CO (US); Joy JACOBS, Northville, MI (US); Hanne BUUR, Boulder, CO (US)

(21) Appl. No.: 18/359,817

(22) Filed: Jul. 26, 2023

(51) Int. Cl. G06F 11/07

(52) U.S. Cl. CPC G06F 11/079; G06F 11/0793

(57) ABSTRACT

Embodiments of the present disclosure relate to a method of detecting an error corresponding to a monitored system. The method may additionally include determining whether the error corresponds to a safety module associated with the monitored system that may have one or more operations that are deemed to affect safety or whether the error corresponds to a safety process associated with the monitored system that may have one or more operations that are deemed to affect safety. In some embodiments, the method may additionally include determining whether to continue operations of the monitored system, where the determination may be based at least on whether the error may correspond to a safety module associated with the monitored system or whether the error corresponds to a safety process associated with the monitored system.

### BACKGROUND

Many systems may be monitored for fault or error detection in order to ensure that the systems are operating safely and effectively during deployment. System errors may include, as examples, one or more flaws, faults, incorrect inputs, incorrect outputs, and/or other issues that may produce one or more incorrect or unexpected results as performed by the monitored system. In some instances, the one or more errors may be caused by a user or a (downstream or upstream) component or feature of a system that may generate or provide one or more incorrect inputs or one or more incorrect outputs (e.g., that may be relied upon as inputs to one or more downstream tasks). In some instances, the one or more errors may be caused by random bit flips or other random errors that may correspond to one or more incorrect or unexpected results. In some instances, one or more errors may cause a system to perform one or more unexpected or incorrect operations, as a minor error may be propagated through a processing pipeline.

In some instances, one or more systems and/or processes may relate to safety. For example, one or more systems may include subsystems, virtual machines, and/or other modules that may perform one or more operations that may be associated with safety, risk mitigation, and/or other operations associated with safety.

In some instances, one or more systems may be configured to detect one or more errors and perform one or more operations in response to the one or more detected errors. For example, some traditional approaches to detecting and compensating for one or more errors may include, upon encountering any error, shut down any and all operations corresponding to the system to mitigate risk. This approach may be particularly relevant for autonomous and/or semi-autonomous systems where system errors and failure may lead to less than desirable control and/or actuation of a machine.

However, these traditional approaches may lead to the system requiring redundant hardware and/or processing, and/or allotting too much compute or memory to performing error detection and mitigation—thus reducing the ability of the system to perform non-error detection or safety related tasks.

### SUMMARY

According to one or more embodiments of the present disclosure, an error corresponding to a monitored system may be detected. In some embodiments, a determination may be made as to whether the error may correspond to a safety module associated with the monitored system, where the safety module may perform one or more operations that may be deemed to affect safety. Additionally or alternatively, in some embodiments, a determination may be made as to whether the error corresponds to a safety process associated with the monitored system, where the safety process may include one or more operations that are deemed to affect safety. In some embodiments, whether to continue operations of the monitored system may be determined. In particular, the determination of whether to continue operations may be based at least on whether the error may correspond to a safety module associated with the monitored system, where the safety module may perform one or more operations that are deemed to affect safety. Additionally or alternatively, the determination of whether to continue operations may be based at least on whether the error corresponds to a safety process associated with the monitored system, where the safety process may include one or more operations that are deemed to affect safety.

The embodiments of the present disclosure may provide the benefits of increasing the effectiveness of one or more systems by classifying processes and/or modules as safety modules or safety processes and correspondingly determining one or more operations to pursue depending on the classification. By determining whether the error and/or module are safety processes and/or safety modules and performing one or more operations based on the determination, effectiveness of the one or more systems corresponding to the error may be improved by continuing performance of one or more operations that may be unaffected by the error even after the error is detected.

### BRIEF DESCRIPTION OF THE DRAWINGS

The present systems and methods for modifying operations of a system based on detected errors are described in detail below with reference to the attached figures, wherein:

FIG. 1 illustrates an environment for handling errors corresponding to a monitored system, in accordance with one or more embodiments of the present disclosure;

FIG. 2 illustrates an example environment for classifying one or more detected errors using the error handling system, in accordance with one or more embodiments of the present disclosure;

FIG. 3 illustrates an example computing system where one or more errors may be detected and/or classified, in accordance with one or more embodiments of the present disclosure;

FIG. 4 is a flow diagram showing a method for error handling, in accordance with one or more embodiments of the present disclosure;

FIG. 5A is an illustration of an example autonomous vehicle, in accordance with one or more embodiments of the present disclosure;

FIG. 5B is an example of camera locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure;

FIG. 6 is a block diagram of an example computing device suitable for use in implementing one or more embodiments of the present disclosure; and

FIG. 7 is a block diagram of an example data center suitable for use in implementing one or more embodiments of the present disclosure.

### DETAILED DESCRIPTION

One or more embodiments of the present disclosure may relate to detecting one or more errors corresponding to one or more modules and/or processes associated with one or more systems. In some embodiments, an error handling system may detect the one or more errors. In some embodiments, the error handling system may be included in the system performing one or more operations. Additionally or alternatively, the error handling system may be configured to detect one or more errors corresponding to one or more other systems separate from the error handling system (e.g., a monitored system). Further, the error handling system may be configured to direct the performance of one or more operations corresponding to the monitored system in response to detecting the one or more errors. In some embodiments, the error handling system may determine whether to continue operations and/or which operations to implement based on whether the error corresponds to a safety process and/or a safety module.

In some embodiments, the error handling system may be configured to determine whether the one or more detected errors may correspond to a safety process. As used herein, the term “safety process” or “safety module” may refer to a designation of the one or more processes and/or modules corresponding to the one or more errors. The designation of being a safety process and/or a safety module may be based on one or more variables and/or considerations that may relate to whether continued operation may adversely affect safety. In some embodiments, by way of example and not limitation, the one or more processes and/or systems associated with one or more errors may be determined to be safety processes and/or modules based on one or more safety regulations imposed by one or more regulatory bodies, one or more industry standards corresponding to the error handling system, the monitored system, and/or other associated systems. Further, the one or more errors may be determined to be safety processes and/or modules based on one or more determinations that one or more systems associated with the error may perform one or more operations that may have an impact on safety that is greater than some a predetermined and measurable threshold.

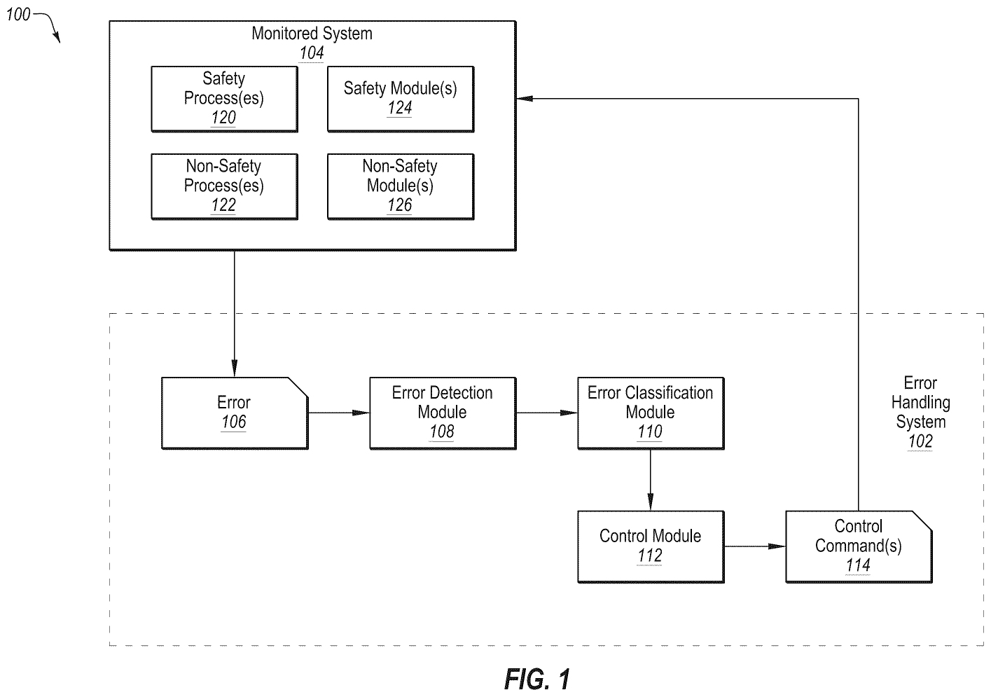

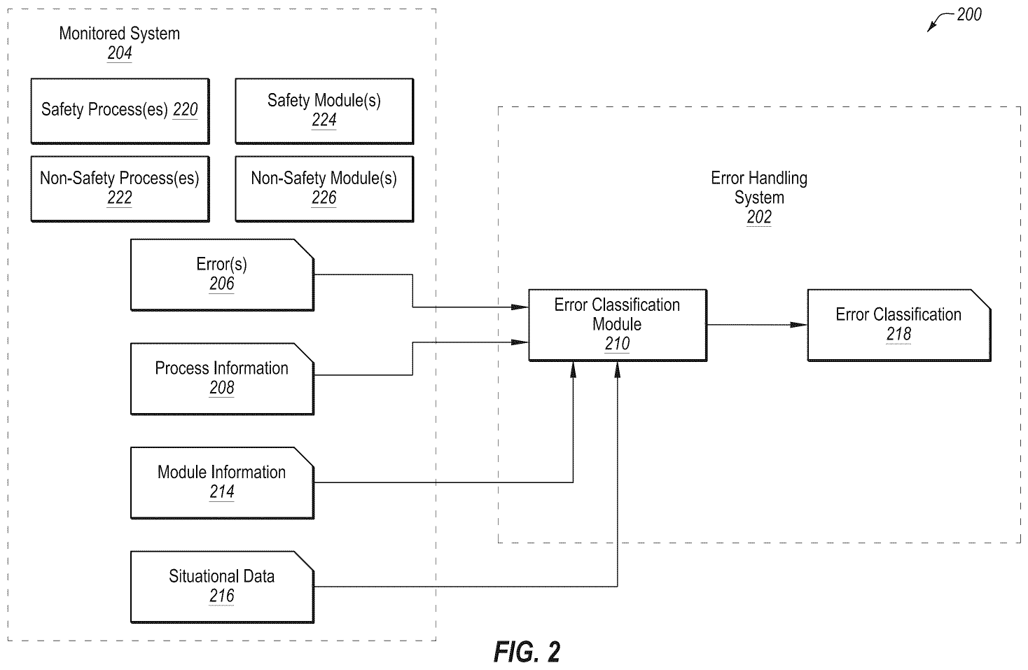

In some embodiments, one or more modules corresponding to the one or more errors may be deemed safety modules. In some embodiments, the one or more modules may be considered safety modules based on one or more of the same considerations used in determining whether the one or more processes may be deemed safety processes. For example, considerations used to determine whether the modules may be deemed safety modules based on safety regulations, industry standards, and/or a measured impact on the safety or performance of the system in view of one or more thresholds, etc. The reduction of safety and the predetermined threshold may be described and illustrated further in the present disclosure, such as, for example, with respect to FIGS. 1 and 2. Further, as used in the present disclosure, reference to one or more modules may include one or more subsets of the one or more modules, such as, for example, one or more virtual machines.

In some embodiments, in response to the determination that the one or more processes and/or the one or more modules may be safety processes or modules, the error handling system may cause the monitored system to perform one or more operations that may stop the monitored system. In some embodiments, stopping the monitored system may include initiating one or more operations to cause performance of a low-risk maneuver. In some embodiments, the low-risk maneuver may correspond to stopping or shutting down the monitored system and/or processes associated with the error. Reference to a low-risk maneuver in the present disclosure may refer to performing one or more operations that may cause the monitored system associated with the one or more errors to stop or shut off in a manner that may be lower risk than immediately causing all operations to stop upon determining that one or more detected errors may correspond to a safety process and/or safety module.

In some embodiments, in response to a determination that the one or more processes and/or the one or more modules may not be deemed safety processes and/or safety modules, the error handling system may direct the monitored system to continue one or more operations. In some embodiments, the error handling system may cause and/or direct the monitored system to continue performing the same operations performed prior to the one or more errors being detected. In some embodiments, one or more operations may be modified in response to detecting one or more errors that may be determined to correspond to one or more modules and/or processes that are not deemed safety modules and/or safety processes. In these and other embodiments, reference to a non-safety module and/or non-safety process may refer to any process and/or module that is not deemed as corresponding to safety—or at least does not have a large enough impact on one or more operations that may compromise the safety of the system.

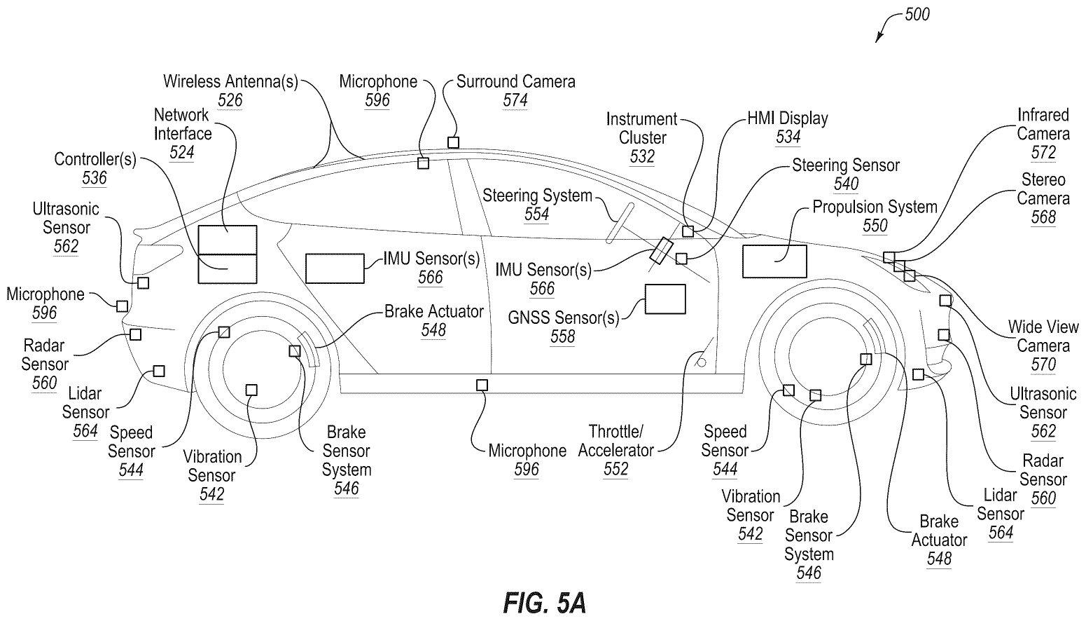

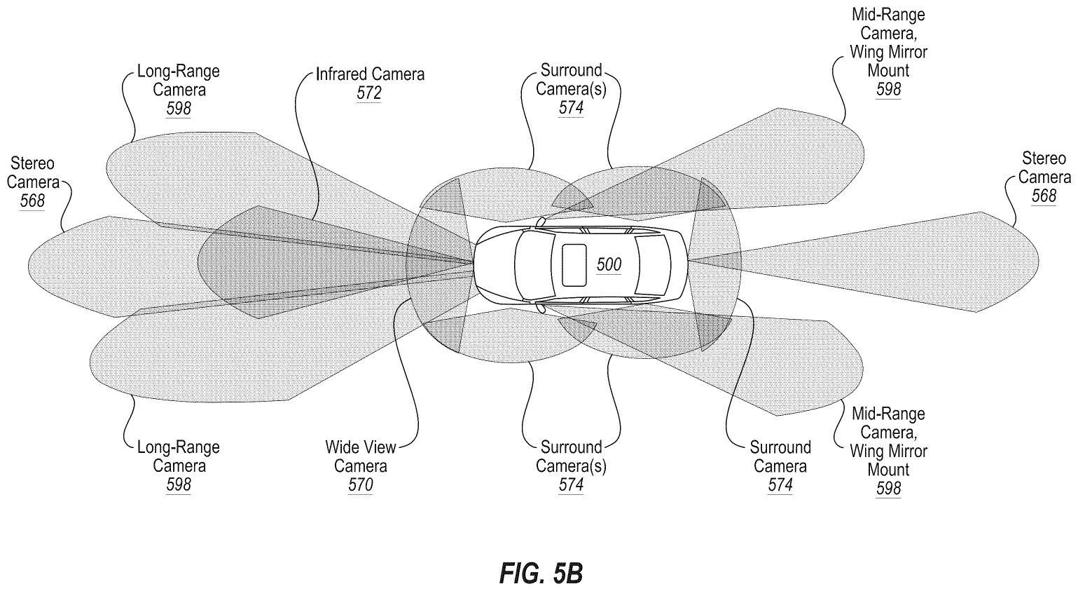

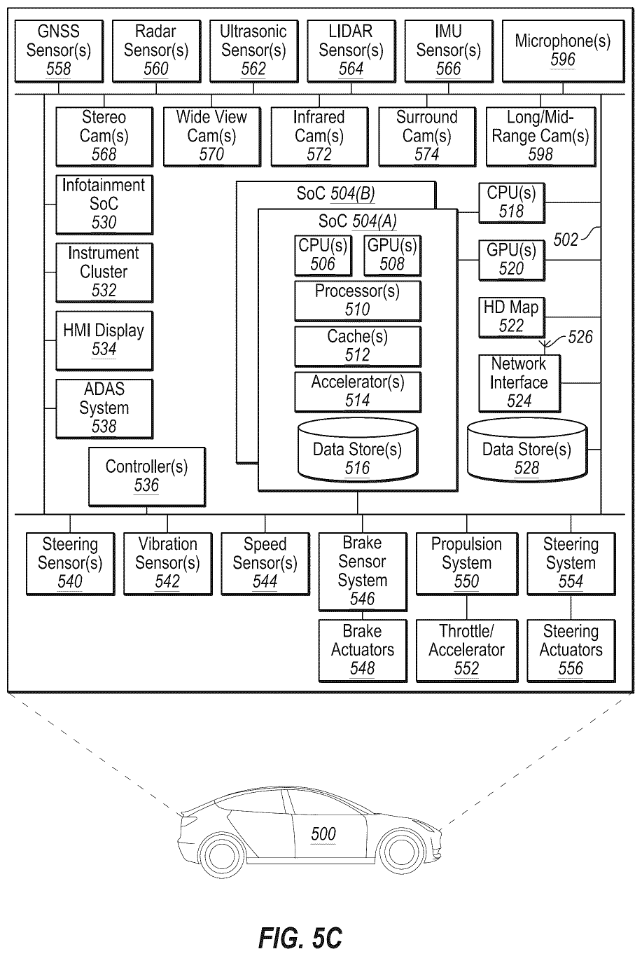

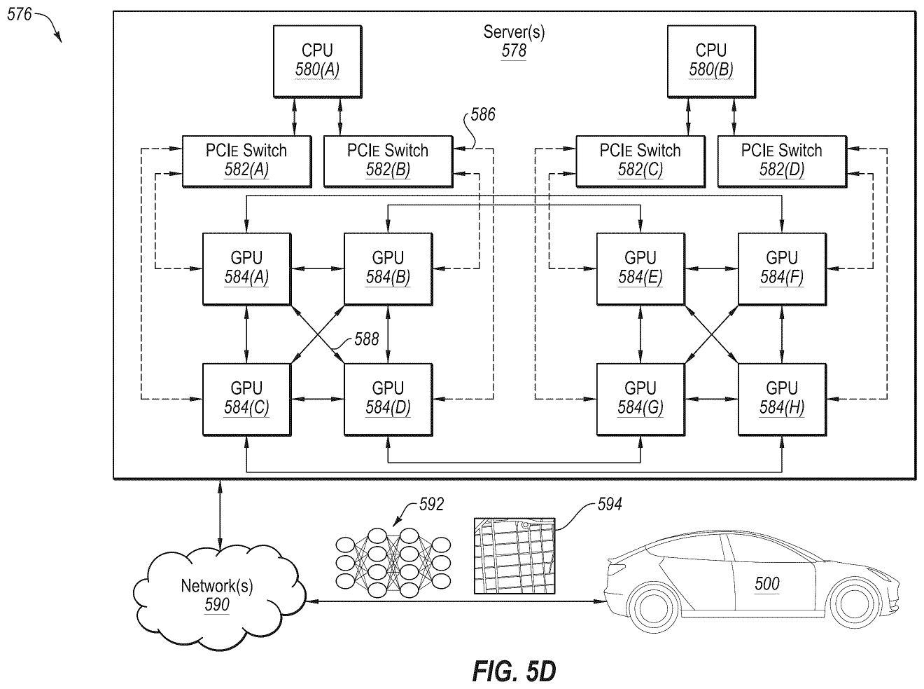

One or more of the embodiments disclosed herein may relate to detecting one or more errors and/or classifying one or more errors as corresponding to one or more safety modules and/or safety processes, where the one or more errors, modules, processes etc. may correspond to one or more ego-machines, which may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 500 (alternatively referred to herein as “vehicle 500” or “ego-machine 500) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

With respect to FIG. 1, FIG. 1 illustrates an environment 100 for handling errors corresponding to a monitored system 104, in accordance with one or more embodiments of the present disclosure. The environment 100 may correspond to many different applications such as autonomous vehicles, industrial robotics, smart home automation, medical robotics, financial automation, aviation, data storage, and any other application where errors may occur in one or more monitored systems 104.

In some embodiments, the environment 100 may include an error handling system 102 configured to detect and/or analyze one or more errors 106 corresponding to the monitored system 104. In these or other embodiments, the error handling system 102 may be configured to cause the monitored system 104 to perform certain error handling operations based on the analyzing of the one or more errors 106.

The monitored system 104 may include one or more systems, devices, integrated systems, processes, machines, modules, and/or other systems that may be monitored for one or more corresponding errors 106. For example, the monitored system 104 may include one or more drones, industrial robots, autonomous vehicles, ego-machines, Internet of Things (IoT) devices, smart home automation systems, climate control systems, and/or any other system that may be monitored for one or more errors 106.

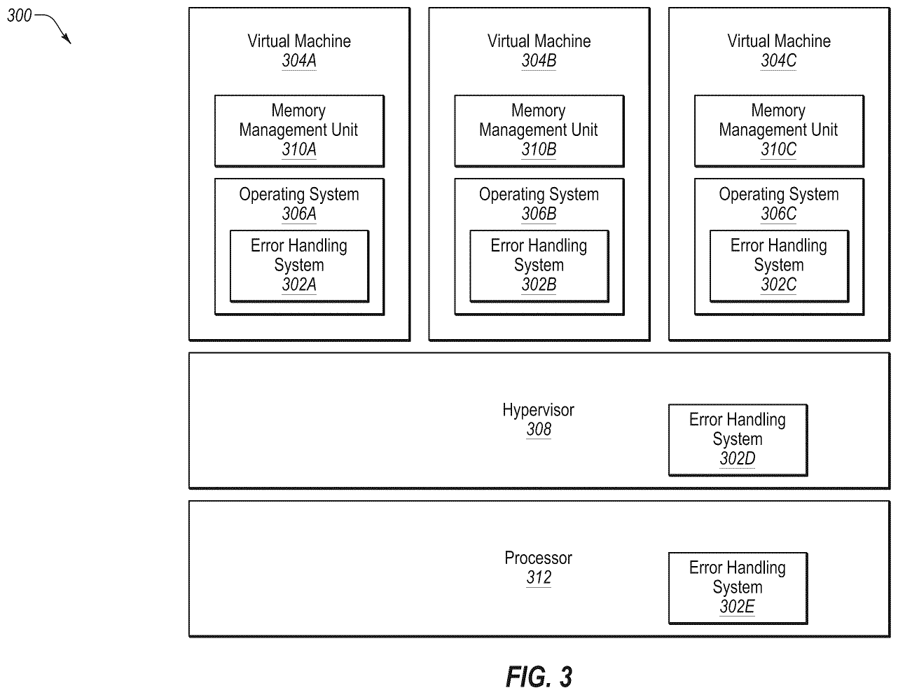

In some embodiments, the monitored system 104 may include one or more subsystems included in one or more systems. For example, in some embodiments, the monitored system 104 may include one or more modules that may be configured to perform one or more operations. Some example modules that may be included in the monitored system 104 may include one or more Bluetooth modules, WiFi modules, perception modules, computing modules, and any other modules that may include and/or encounter one or more errors 106. Additional examples of modules that may be included in the monitored system may be described and/or illustrated in the present disclosure, such as, for example, with respect to virtual machine(s) 304, memory management units 310, operating system 306, and/or hypervisors 308 of FIG. 3.

Additionally or alternatively, the monitored system 104 may include and/or be configured to execute one or more processes. In these or other embodiments, a computing system and/or one or more modules of the monitored system 104 may include and/or be configured to execute the one or more processes.

In some embodiments, the monitored system 104 may include one or more processes and/or modules that may be deemed one or more safety processes 120 and/or safety modules 124. In some embodiments, the monitored system 104 may additionally include one or more processes and/or modules that may be deemed non-safety processes 122 and/or non-safety modules 126.

In some embodiments, the designation corresponding to the safety process 120 and/or a safety module 124 may be based on one or more variables and/or considerations that may relate to whether one or more operations corresponding to the module and/or process may be associated with safety. In some embodiments, it may be determined that the module and/or process does not affect safety (or has a minimal or negligible impact), as a result, the module and/or process may be designated as a non-safety process 122 and/or a non-safety module 126.

In some embodiments, for example, the one or more processes and/or modules may be determined to be safety processes 120 and/or safety modules 124 and, conversely, non-safety processes 122 and/or non-safety modules 126, based on one or more internal designations. In some embodiments, the designation that a module and/or process may be a safety module 124 and/or a safety process 120 may be based on one or more safety regulations imposed by one or more regulatory bodies and/or industry standards corresponding to the monitored system 104 and/or other associated systems. Further, the one or more modules and/or processes may be deemed safety processes 120 and/or safety modules 124 based on the determination that one or more operations associated with the module and/or system may perform one or more operations that may increase one or more risks of harm to systems, property, individuals, etc. In some examples, internal testing may be performed to determine the impact of a component, feature, process, operation, or module on downstream decision making, and those modules and/or processes that have a greater, perceivable, tangible, and/or impactful effect on the operation of the system may be tagged or designated as safety operations or modules. There may also be level of safety allocations, such as high risk, medium risk, low risk, or no risk, and different actions may be taken in response to these differently classified modules or operations failing or having errors detected.

For example, in the context of the monitored system 104 included in one or more ego-machines, the U.S. Department of Transportation's National Highway Traffic and Safety Administration (NHTSA) may create one or more safety regulations corresponding to ego-machines travelling on highways and other roads in the United States. Continuing the example, one or more processes and/or modules may perform or cause the performance of one or more operations that may affect the ego-machine such that the ego machine and/or performance of the ego machine may not be consistent with regulations and/or safety standards created by the NHTSA. In response to the one or more modules and/or processes affecting the ego machine in this manner, the modules and/or processes may be considered safety modules 124 and/or safety processes 120. Additionally or alternatively, one or more modules and/or processes may be deemed non-safety modules 126 and/or non-safety processes 122 based on the modules and/or processes not performing and/or causing performance of one or more operations that may affect the ego machine in a way that may cause the ego machine and/or performance of the ego machine to be inconsistent with the safety standards created by the NHTSA.

In some embodiments, one or more processes and/or modules may be deemed as safety processes 120 and/or safety modules 124 based on one or more industry standards corresponding to the monitored system 104. For example, in the context of the monitored system 104 included in one or more ego-machines, the international organization for standardization (ISO) 26262 may establish one or more standards corresponding to functional safety of electrical systems that are installed in road vehicles (e.g., ISO 26262). Continuing the example, it may be determined that a process, module, and/or one or more resulting operations corresponding to the process and/or module may render the ego-machine compliant or non-compliant with the standards associated with ISO 26262. In response to the resulting operations rendering the ego-machine compliant or non-compliant with the standards corresponding to ISO 26262, the module and/or process may be designated as a safety process 120 and/or safety module 124.

In some embodiments, it may be determined that a process and/or module may correspond to a safety process 120 and/or a safety module 124 based on a determination that the process and/or module may perform one or more operations and/or cause one or more operations to be performed, that may decrease the overall safety of the system beyond a predetermined threshold. In some embodiments, the determination may be made considering one or more mis-operations and/or potential errors (e.g., the one or more errors 106). It may be determined that a process and/or module may perform one or more operations with one or more errors 106 where the one or more errors 106 included in the operations may increase the risk of improper control or other operations beyond a predetermined threshold.

In some embodiments, the decrease in safety or the risk of harm may include risks of economic loss. For example, the monitored system 104 and/or other systems corresponding to the monitored system 104 may perform one or more operations that may cause damage to the monitored system 104, the error handling system 102, and/or a corresponding system. In some embodiments, the damage caused may result in economic loss to one or more owners of the monitored system 104 and/or one or more other corresponding systems.

In some embodiments, the risk of harm may include risks of property damage and/or economic loss outside of the monitored system 104 and/or systems corresponding to the monitored system 104. In some embodiments, the monitored system 104 and/or one or more corresponding systems may perform one or more operations that may result in damage to property. In some embodiments, the one or more operations may increase a risk of damage to property that may not be associated with the monitored system 104 and/or one or more corresponding systems.

For example, in the context of a drone that may be associated with the monitored system 104, operations associated with one or more processes and/or modules corresponding to the drone may cause the drone to fly lower to the ground in such a way that the drone may not itself incur any damage, but the flight may distract and/or confuse one or more drivers on the road below such that the one or more operations may impact the safety of others or others property even if not associated with the drone and/or the corresponding monitored system 104. Therefore, as a result of the increase in risk or reduction in safety, the process and/or module corresponding to the operations may be determined to be a safety process 120 and/or a safety module 124.

In some embodiments, the reduction in safety or risk of harm may correspond to individuals. For example, in the context of the monitored system 104 corresponding to a robot, one or more operations associated with a process and/or a module corresponding to the robot may cause an arm of the robot to rotate. Continuing the example, the arm of the robot rotating may not present a risk of damage to the robot itself, however, one or more individuals may be close to the robot and the rotating arm may be a risk to the one or more individuals in the area surrounding the robot. As a result, the process and/or module associated with the one or more operations may be determined to be a safety process 120 and/or a safety module 124.

As another example, the monitored system 104 may include an industrial robot where the industrial robot may be in close proximity to other systems and/or individuals. Continuing the example, a perception module corresponding to the industrial robot may be deemed a safety module 124 in response to one or more operations performed using the perception module increasing the potential of risk to individuals and other systems that may be in close proximity to the industrial robot.

Additionally or alternatively, continuing the example of the monitored system 104 as an industrial robot, the industrial robot may include a WiFi module that may be configured to allow the industrial robot to connect to one or more other devices—e.g., speakers, computing devices, controllers, etc. The WiFi module may not correspond to operations that may increase a risk to the industrial robot and/or one or more individuals in proximity to the industrial robot. Therefore, on that basis, the WiFi module and/or processes associated therewith may be designated as non-safety processes 122 and/or a non-safety module 126.

In some embodiments, it may be determined that a process and/or module may correspond to a safety process 120 and/or a safety module 124 based on whether an error 106 associated with the process and/or module may affect one or more measurable safety metrics. In some embodiments, the measurable safety metrics may include one or more quantitative and/or qualitative measures that may be used to assess and/or evaluate a level of safety and/or performance corresponding to the monitored system 104. In some embodiments, the measurable safety metrics may correspond to one or more portions of the monitored system 104, the monitored system 104 as a whole, the environment 100 corresponding to the monitored system 104, one or more individuals corresponding to the monitored system 104, one or more other systems corresponding to the monitored system 104, etc.

In some embodiments, the measurable safety metrics may include an accuracy of one or more portions of the monitored system 104, a level of responsiveness to one or more control commands corresponding to the monitored system 104, a likelihood of failure or decreased performance of one or more components and/or portions of the monitored system 104, etc. In some embodiments, it may be determined that the error 106 may affect the one or more measurable safety metrics in response to the one or more measurable safety metrics falling beneath and/or rising above one or more thresholds.

For example, in the context of the monitored system 104 as an ego-machine, the ego-machine may include a perception module whereby one or more machine learning models, neural networks, deep neural networks, and the like may be configured to make one or more predictions based on input data. Continuing the example, a measurable safety metric may include an amount of accuracy with which the perception module may make correct predictions corresponding to the input data. Further continuing the example, the one or more errors 106 may affect the perception module such that the accuracy with which the perception module may make correct predictions may fall below one or more predetermined thresholds. In response to the error 106 affecting the perception module in this manner, it may be determined that the error 106 may correspond to a safety process 120 and/or a safety module 124.

In some embodiments, the determination that one or more processes and/or modules associated with the one or more errors 106 may be considered safety processes 120 and/or safety modules 124 may be made using one or more global modules (e.g., a CPU, a hypervisor, etc.). In some embodiments, determining whether a module and/or process may be a safety process 120 and/or a safety module 124 may be made using a global module in response to the global module having access to additional data and/or information corresponding to one or more other modules and/or processes associated with the monitored system 104.

For example, in the context of the monitored system 104 including a swarm of aerial drones, one or more processes may correspond to a Bluetooth module. The Bluetooth module may be one way that the aerial drones connect and/or communicate with each other. Continuing the example, one or more processes corresponding to the Bluetooth module may not, alone, be designated as a safety process 120 because the process may simply allow a drone to connect to one or more other Bluetooth devices. However, continuing the example, the Bluetooth module may be considered a safety module 124 in response to one or more operations corresponding to the Bluetooth module affecting other modules, for example, a communication module and/or a perception module. In response to the one or more errors 106 having an effect on multiple modules and/or processes, a global module may be used to determine whether the processes and/or modules may be safety processes 120 and/or safety modules 124.

In some embodiments, the determination that the one or more processes and/or the one or more modules may be safety processes 120 and/or safety modules 124 may be made dynamically, at least in part, based on data and/or information corresponding to the environment associated with the monitored system 104. In these and other embodiments, one or more dynamic determinations corresponding to whether the process and/or module may be a safety process 120 and/or a safety module 124 may be described and/or illustrated further in the present disclosure, such as, for example, with respect to FIG. 2.

In some embodiments, the monitored system 104, the one or more safety processes 120, non-safety processes 122, safety modules 124, and/or non-safety modules 126 may include, encounter, and/or produce one or more errors 106.

In some embodiments, the one or more errors 106 may include one or more flaws, faults, incorrect inputs, and/or other circumstances that may produce one or more incorrect or unexpected results as performed by the monitored system 104. In some instances, the one or more errors 106 may be caused by a user or other system that may have used one or more incorrect inputs corresponding to the monitored system 104. In some instances, the one or more errors 106 may be caused by random bit flips or other random errors that may correspond to one or more incorrect or unexpected results.

In some embodiments, the one or more errors 106 may include memory errors, for example storing data in one or more incorrect data storage locations, buffer overflows, pointer errors, and other errors associated with memory and storage locations. In some embodiments, the one or more errors 106 may cause the monitored system 104 to perform one or more unexpected or incorrect operations.

In some embodiments, the one or more errors 106 may include information corresponding to the one or more errors 106. For example, the one or more errors 106 may include one or more error messages, values, notifications, and/or other indicators that one or more errors 106 may have occurred.

The one or more errors 106 may be indicated using any data type that may be suitable for conveying information corresponding to the one or more errors 106. In some embodiments, the data type corresponding to the one or more errors 106 may include integers, floats, chars, strings, Booleans, and other data types indicating information and/or a lack of information corresponding to the one or more errors 106.

In some embodiments, the one or more errors 106 may include data and/or information indicating one or more sources of the one or more errors 106. For example, the one or more errors 106 may include data and/or information that may indicate that the one or more errors 106 may have been caused by an incorrect input from one or more sources (e.g., external sources, other modules, virtual machines, systems corresponding to the monitored system 104, etc.).

In some embodiments, the one or more errors 106 may include information that may indicate one or more processes and/or modules that may be associated with the one or more errors 106. For example, the one or more errors 106 may include information that the one or more errors 106 may have occurred in a process corresponding to a perception module associated with the monitored system 104. As an additional example, the one or more errors 106 may include information that may indicate the one or more errors 106 occurred in a process configured to connect one or more systems to a WiFi signal.

In some embodiments, the one or more errors 106 corresponding to the monitored system 104 may be detected using the error handling system 102. In some embodiments, the error handling system 102 may be configured to determine whether the one or more errors 106 may correspond to one or more safety modules 124, non-safety modules 126, safety processes 120, and/or non-safety processes 122.

In some embodiments, the error handling system 102 may include one or more systems, devices, processes, integrated processes, modules, etc. that may be configured to monitor one or more systems (e.g., the monitored system 104) for errors (e.g., the errors 106). For example, the error handling system 102 may include one or more computing systems, controllers, or other control systems that may be configured to monitor the monitored system 104 for the one or more errors 106. Further, the error handling system 102 may include portions of the same systems as the monitored system 104, such as, drones, industrial robots, autonomous vehicles, ego-machines, Internet of Things (IoT) devices, smart home automation systems, climate control systems, etc.

In some embodiments, the error handling system 102 may be included in the monitored system 104. Additionally or alternatively, the error handling system 102 may be a system separate and apart from the monitored system 104, and that may cause the monitored system 104 to perform one or more operations. In some embodiments, the error handling system 102 may cause the monitored system 104 to perform one or more operations based on the one or more errors 106.

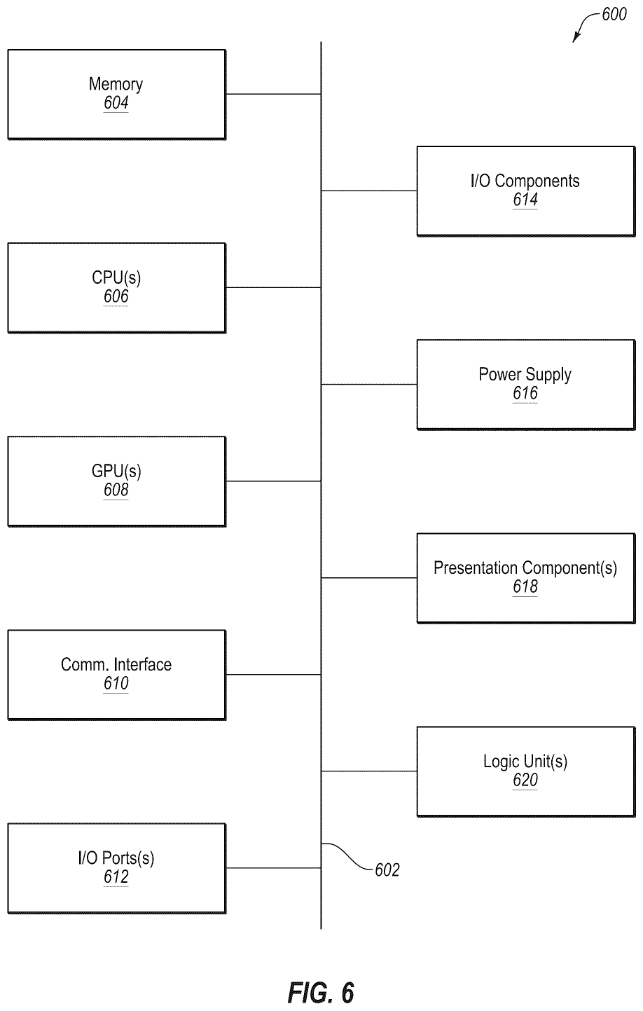

In some embodiments, the error handling system 102 may include one or more modules including, for example, an error detection module 108, an error classification module 110, and/or a control module 112. In these or other embodiments, the one or more modules corresponding to the error handling system 102 may be implemented using hardware including one or more processors, central processing units (CPUs) graphics processing units (GPUs), data processing units (DPUs), parallel processing units (PPUs), microprocessors (e.g., to perform or control performance of one or more operations), programmable vision accelerators (PVAs)—which may include one or more direct memory access (DMA) systems and/or one or more vector or vision processing units (VPUs), field-programmable gate arrays (FPGA), application-specific integrated circuits (ASICs), accelerators (e.g., deep learning accelerators (DLAs)), and/or other processor types. In some other instances, one or more of these modules may be implemented using a combination of hardware and software. In the present disclosure, operations described as being performed by the one or more modules corresponding to the error handling system 102 (e.g., the error detection module 108, the error classification module 110, and/or the control module 112) may include operations that the one or more modules may direct one or more corresponding computing systems to perform. In these or other embodiments, the one or more modules may be implemented by one or more computing devices, such as that described in further detail with respect to FIGS. 5A-5D, 6, and/or 7.

In some embodiments, the error detection module 108 may be configured to detect the one or more errors 106. In some embodiments, the error detection module 108 may be configured to actively monitor the monitored system 104 and detect, report, and/or otherwise determine that the one or more errors 106 may have occurred. Additionally or alternatively, the error detection module 108 may receive and/or otherwise obtain the one or more errors 106. Further, the error detection module 108 may be configured to determine one or more sources corresponding to the one or more errors 106.

In some embodiments, the error detection module 108 may be a local module. As used in the present disclosure, “local module” may refer to a module that may include and/or have access to information corresponding to processes in one virtual machine associated with monitored system 104.

For example, in the context of the monitored system 104 as an ego-machine, the ego-machine may include a Bluetooth virtual machine. The Bluetooth virtual machine may be configured to perform one or more Bluetooth operations corresponding to the ego-machine—e.g., connect with one or more other devices, share information, etc. Continuing the example, the error detection module 108 may be included and/or associated with the Bluetooth virtual machine. Further, the one or more errors 106 corresponding to Bluetooth operations may be detected using the error detection module 108. Because the error detection module 108 may be included in and/or associated with the Bluetooth virtual machine, it may be a local error detection module 108.

In these and other embodiments, an example error detection module 108 as a local module may be described and/or illustrated further in the present disclosure, such as, for example, with respect to the one or more memory management units 310 in FIG. 3.

In some embodiments, the error detection module 108 may be a global module corresponding to the error handling system 102. As used in the present disclosure, “global module” may refer to a module that may include and/or have access to information corresponding to more than one virtual machine associated with the monitored system 104. In some embodiments, the error detection module 108 may detect one or more errors 106 that may have originated and/or may affect multiple modules, virtual machines, and/or other systems that may be associated with the monitored system 104. In some embodiments, the error detection module 108 as a global module may be configured to detect the one or more errors 106 between different virtual machines, the one or more errors 106 that may correspond to the monitored system 104 as a whole, etc.

In these and other embodiments, an example of the error detection module 108 as a global module may be described and/or illustrated further in the present disclosure, such as, for example, with respect to a hypervisor 308 described with respect to FIG. 3.

In some embodiments, the error detection module 108 may be configured to communicate information corresponding to the one or more detected errors 106 to one or more other modules and/or systems corresponding to the error handling system 102. For example, the error detection module 108 may be configured to communicate information corresponding to the one or more detected errors 106 to the error classification module 110.

In some embodiments, the error detection module 108 may be configured to determine one or more operations to perform and/or to cause to be performed based on the one or more errors 106. In some embodiments, the error detection module 108 may direct operations corresponding to the one or more errors 106 to stop while it is being determined that the one or more errors 106 may correspond to a safety process 120 and/or a safety module 124.

In some embodiments, the determination that the one or more errors 106 may be associated with a safety process 120 and/or a safety module 124 may be performed by the error detection module 108. In some embodiments, the determination that the one or more errors 106 may be associated with a safety process 120 and/or a safety module 124 may be performed by one or more other modules, processes, and/or systems corresponding to the error handling system 102, such as, for example, the error classification module 110.

The error classification module 110 may be configured to perform one or more operations to determine whether the one or more errors 106 may correspond to safety processes 120 and/or safety modules 124. In some embodiments, the error classification module 110 may determine that the one or more errors 106 may correspond to one or more safety processes 120 and/or safety modules 124 based on one or more designations made previously that the process may be a safety process 120 and/or a module may be a safety module 124. Additionally or alternatively, the error classification module 110 may dynamically determine that a process and/or module may be a safety process 120 and/or safety module 124 based on one or more factors referred to herein (e.g., one or more regulations, industry standards, internal designations, increase of risk to harm, etc.). In some embodiments, such determinations may be different from or override one or more previous designations. Additionally or alternatively, such determinations may be made in the absence of one or more designations. In some embodiments, the error classification module 110 may perform one or more operations described with respect to FIG. 2 with respect to making such dynamic determinations.

In some embodiments, the error classification module 110 may be a local module and/or a global module. An example of the error classification module 110 as a local module may be described and/or illustrated further in the present disclosure, such as, for example, with respect to one or more Memory Management Units (MMU) 310 and/or operating systems 306 in FIG. 3. An example of the error classification module 110 as a global module may be described and/or illustrated further in the present disclosure, such as, for example, with respect to an error handling system 302 and/or a hypervisor 308 described with respect to FIG. 3.

In some embodiments, the error classification module 110 may be configured to send and/or otherwise communicate the designation that a process and/or module corresponding to the one or more errors 106 may be safety process 120 and/or safety module 124 to one or more other modules or systems, for example, the control module 112. In some embodiments, the control module 112 may be configured to generate one or more control commands 114 based on one or more determinations made corresponding to the error classification module 110.

In some embodiments, the control module 112 may be configured to analyze information corresponding to the one or more errors 106 and/or the determination that the process and/or module corresponding to the one or more errors 106 may be a safety process 120 and/or safety module 124. In some embodiments, the control module 112 may generate one or more control commands 114 that may cause one or more operations to be performed by the monitored system 104 and/or one or more other systems, modules, virtual machines, etc. associated with the monitored system 104.

In some embodiments, in response to the determination that the one or more processes and/or modules corresponding to the one or more errors 106 may be safety processes 120 and/or safety modules 124, one or more control commands 114 may be generated that may stop the monitored system 104 and/or the one or more systems associated with the monitored system 104. In some embodiments, stopping the monitored system 104 and/or the one or more systems corresponding to the monitored system 104 may include initiating one or more operations included in a low-risk maneuver to stop the monitored system 104 and/or systems corresponding to the monitored system 104.

In some embodiments, in response to a determination that the process and/or the module corresponding to the one or more errors 106 may not be a safety process 120 or a safety module 124, the control module 112 may generate one or more control commands 114 that may cause the monitored system 104 and/or systems corresponding thereto to continue one or more operations. In some embodiments, the control module 112 may generate control commands 114 that may cause the monitored system 104 to continue performing the same operations performed prior to the one or more errors 106 being detected.

In some embodiments, the control module 112 may generate one or more control commands 114 that may direct the monitored system 104 and/or corresponding systems to change and/or modify one or more operations. For example, continuing in the context of the monitored system 104 as a robot with the one or more errors 106 causing an arm of the robot to rotate unpredictably, the error classification module 110 corresponding to the robot may determine that the one or more errors 106 may correspond to a safety process 120 and/or a safety module 124. In response to the determination by the error classification module 110, the control module 112 may be configured to generate one or more control commands 114 that may direct the robot to stop using the arm entirely and to continue other operations unless and until the one or more errors 106 may be fixed and/or otherwise resolved.

Modifications, additions, or omissions may be made to FIG. 1 without departing from the scope of the present disclosure. For example, the number of errors 106 may vary. Further, the number of modules performing operations corresponding to the error detection module 108, the error classification module 110, and/or the control module 112 may vary. For example, one module may be configured to perform all of the operations corresponding to the error detection module 108, the error classification module 110, and the control module 112. In some embodiments, the error handling system 102 may correspond to one or more other systems and/or modules to which the one or more errors 102 may correspond. Additionally or alternatively, the error handling system 102 may be included in the monitored system 104 and/or the one or more errors 106 may correspond to one or more processes and/or modules corresponding to the error handling system 102.

FIG. 2 illustrates an example environment 200 for classifying one or more errors 206, in accordance with one or more embodiments of the present disclosure. In some embodiments, the environment 200 may include an error-handling system 202 that may be configured to classify one or more errors 206 as corresponding to one or more of a safety process 220, a non-safety process 222, a safety module 224, and a non-safety module 226.

In some embodiments, the error handling system 202 may be the same as and/or analogous to the error handling system 102 described and/or illustrated further in the present disclosure, such as, for example, with respect to FIG. 1.

In some embodiments, the monitored system 204 may be the same as and/or analogous to the monitored system 104 described and/or illustrated further in the present disclosure, such as, for example, with respect to FIG. 1.

In some embodiments, the error classification module 210 may be the same as and/or analogous to the error classification module 110 described and/or illustrated further in the present disclosure, such as, for example, with respect to FIG. 1. In the illustrated example of FIG. 2, the error classification module 210 may be configured to determine respective error classifications 218 for the errors 206 based on process information 208, module information 214, and/or situational data 216 in some embodiments.

In some embodiments, the one or more errors 206 may include both errors and/or one or more indicators corresponding to the one or more errors 206. Additionally or alternatively, the one or more errors 206 may additionally include error information corresponding to the one or more errors 206—e.g., indications regarding to which processes, modules, and/or systems the errors 206 correspond and/or indications regarding which processes, modules, and/or systems may be affected by the one or more errors 206. In some embodiments, the one or more errors 206 may be the same as and/or analogous to the errors 106 described and illustrated further in the present disclosure, such as, for example, with respect to FIG. 1.

In some embodiments, the process information 208 may include data and/or information that may correspond to one or more processes associated with the one or more errors 206. In some embodiments, the process information 208 may include information corresponding to one or more other modules, processes, systems, etc. that may be affected by one or more operations performed and/or caused to be performed by one or more processes corresponding to the one or more errors 206.

In some embodiments, the process information 208 may include one or more designations that may have been made by one or more users, systems, entities, or others that may have designated which processes may be safety processes 220 and which may be non-safety processes. In some embodiments, the designation that a process may correspond to a safety process 220 or a non-safety process 222 may be described and/or illustrated further in the present disclosure, such as, for example, with respect to the monitored system 104 in FIG. 1.

In some embodiments, the process information 208 may include information corresponding to one or more processes that may be used to make a determination as to whether the respective process may be a safety process 220 or a non-safety process 222. Additionally or alternatively, the process information 208 may include information about relationships corresponding to one or more processes. For example, the process information 208 may include one or more other processes and/or modules that may be affected by a particular process and/or operations that may be associated with the particular process.

In some embodiments, the process information 208 may include information corresponding to how one or more processes may be affected by one or more external factors. For example, the process information 208 may include one or more inputs coming from external sources, environmental factors impacting a performance corresponding to the monitored system 204. Further, the process information 208 may include one or more impacts on the monitored system 204 and/or one or more associated systems, the one or more impacts resulting from the one or more inputs and/or environmental factors corresponding to one or more other systems, subsystems, processes, modules, etc.

In some embodiments, one or more designations corresponding to the one or more processes may be included in the process information 208. For example, an entity that may own or otherwise control the monitored system 204 and/or the error handling system 202 may have determined that one or more processes associated with the monitored system 204 may be safety processes 220 or non-safety processes 222. Continuing the example, the designation corresponding to the one or more processes may be included in the process information 208. Additionally or alternatively, the process information 208 may be used, for example, to determine whether one or more processes corresponding to the monitored system 204 may be a safety process 220 and/or a non-safety process 222.

In some embodiments, module information 214 may include data and/or information that may correspond to one or more modules associated with the one or more errors 206. In some embodiments, the module information 214 may include information corresponding to operations that may be performed and/or caused by one or more modules and/or processes corresponding to one or more modules. In some embodiments, the module information 214 may include information corresponding to one or more other modules, processes, systems, etc. that may be affected by one or more operations performed and/or caused to be performed by one or more modules corresponding to the one or more errors 206.

In some embodiments, the module information 214 may include one or more designations made using the monitored system 204 to which the one or more modules may correspond. For example, the monitored system 204 may designate one or more modules as a safety module 224 and/or a non-safety module 226. In these or other embodiments, the monitored system 204 determining whether a module may be a safety module 224 or a non-safety module 226 may be described and/or illustrated further in the present disclosure, such as, for example, with respect to FIG. 1.

In some embodiments, the module information 214 may include information corresponding to one or more modules that may be used to make a determination as to whether the respective module may be a safety module 224 or a non-safety module 226. Additionally or alternatively, the module information 214 may include information about relationships corresponding to one or more modules. For example, the module information 214 may include one or more other modules, virtual machines, processes, systems, operations, etc. that may be affected by a particular module and/or operations that may be associated with the particular module.

In some embodiments, the module information 214 may include information corresponding to how one or more modules may be affected by one or more external factors. For example, the module information 214 may include one or more inputs coming from external sources, environmental factors impacting a performance corresponding to the monitored system 204. Further, the module information 214 may include one or more impacts on the monitored system 204 and/or one or more associated systems, the one or more impacts resulting from the one or more impacts and/or environmental factors corresponding to one or more other systems, subsystems, processes, modules, etc.

In some embodiments, one or more designations corresponding to the one or more processes may be included in the module information 214. For example, an entity that may own or otherwise control the monitored system 204 and/or the error handling system 202 may have determined that one or more processes associated with the monitored system 204 may be safety modules 224 or non-safety modules 226. Continuing the example, the designation corresponding to the one or more modules and/or virtual machines may be included in the module information 214. Additionally or alternatively, the module information 214 may be used, for example, to determine whether one or more modules and/or virtual machines corresponding to the monitored system 204 may be a safety module 224 and/or a non-safety modules 226.

In some embodiments, situational data 216 may include data and/or information corresponding to one or more devices, machines, and other systems corresponding to the one or more errors 206 (e.g., the monitored system 204). In some embodiments, the situational data 216 may include one or more characteristics corresponding to the one or more systems. For example, the system may include particular dimensions (e.g., height, weight, length, etc.), transmission, energy consumption, what type of energy the one or more systems may consume (e.g., gasoline, diesel fuel, electricity, etc.), temperature tolerances, speed tolerances, whether the system is waterproof, and any other characteristics that may correspond to the monitored system 204 associated with the one or more errors 206.

In some embodiments, the situational data 216 may include data and/or information that may be collected, or otherwise obtained corresponding to the monitored system 204 and/or the environment within which the monitored system 204 may be. In some embodiments, the situational data 216 may include data and/or information obtained using one or more sensors corresponding to the monitored system 204. For example, the monitored system 204 may include temperature sensors, speed sensors, sensors indicating fuel levels, tire pressure sensors, and other sensors that may generate sensor data corresponding to the monitored system 204.

In some embodiments, the situational data 216 may include data and/or information corresponding to the environment within which the monitored system 204 may perform one or more operations. In some embodiments, the situational data 216 may include data generated using one or more sensors that may generate data corresponding to the environment. For example, the monitored system 204 may include one or more image sensors, light detection and ranging (LiDAR) sensors, Radio Detection and Ranging (RADAR) sensors, and/or other sensors that may generate data indicating one or more characteristics of the environment surrounding the monitored system 204. Continuing the example, the one or more image sensors may indicate that individuals, property, other systems, roadways, and/or other environmental features may be included in the environment surrounding the monitored system 204.

In some embodiments, the situational data 216 may include historical data, data obtained from one or more other systems that may be separate from the monitored system 204 and/or the error handling system 202, and/or any other source of data and/or information corresponding to the environment within which the monitored system 204 may be. For example, historic weather data corresponding to the area, videos taken by one or more other systems in the area, public information indicating accidents or other obstructions in the environment, construction zones, global positioning system (GPS) data, etc.

In some embodiments, the error classification module 210 may designate that that the one or more errors 206 may correspond to a safety process 220, a non-safety process 222, a safety module 224, or a non-safety module 226 using the process information 208 and/or the module information 214 with respect to one or more of the criteria described further in the present disclosure, such as, for example, with respect the monitored system 104 in FIG. 1.

Additionally or alternatively, the error classification module 210 may be configured to determine whether one or more errors 206 may correspond to a safety process 220 and/or a safety module 224 dynamically using the situational data 216, the one or more errors 206, the process information 208, and/or the module information 214. In some embodiments, dynamically determining and/or classifying one or more errors 206 may include determining and/or redetermining whether the one or more errors 206 individually correspond to one or more of a safety process 220, non-safety process 222, safety module 204, or non-safety module 226 at one or more time stamps. For example, one or more errors 206 that may have been classified as corresponding to a non-safety process 222 and/or non-safety module 226 at a first time stamp may be classified as a safety process 220 and/or a safety module 224 at a second time stamp.

By way of example and not limitation, the monitored system 204 may include an autonomous robot, the one or more errors 206 may correspond to a process moving an arm of the autonomous robot. Further, the process performing operations with the one or more errors 206 may cause the autonomous robot to move an arm in an unpredictable manner. It may be determined that the process and/or module may be a non-safety process 222 and/or a non-safety module 226 in response to the arm of the autonomous robot not causing any damage to the system, one or more other systems, individuals, etc. However, the error classification module 210 may obtain situational data 216 that includes information that one or more individuals may be within a threshold proximity to the autonomous robot. Further, because the unpredictably rotating arm may collide with the individual, the error classification module 210 may then designate that the one or more errors 206 corresponds to a safety process 220 and/or a safety module 224 at a time stamp corresponding to the individual crossing into the threshold proximity of the autonomous robot.

As an additional example of dynamically classifying whether one or more errors 206 correspond to one or more of a safety process 220, a safety module 224, a non-safety process 222, and a non-safety module 226, the monitored system 204 may include an autonomous vehicle. Further, the error classification module 210 may obtain and/or receive one or more errors 206 that may correspond to a WiFi module corresponding to the autonomous vehicle. Continuing the example, the WiFi module may be configured to allow the autonomous vehicle to communicate with one or more other ego-machines. At a first time stamp in the environment, the WiFi module may be determined to be a safety module 224 in response to a large amount of traffic where it may be determined that the autonomous vehicle may use the WiFi module to create one or more virtual lanes with one or more other ego-machines in the environment. At a second time stamp, the error classification module 210 may redetermine that the one or more errors 206 may correspond to a non-safety module 226 in response to a decrease in traffic where the autonomous vehicle may no longer use the WiFi module to communicate with one or more other ego-machines to form one or more virtual lanes.

In some embodiments, the error classification 218 may be used by the error handling system 202 to perform one or more operations or cause one or more operations to be performed by the monitored system 204. For example, the error handling system 202 may use the error classification 218 to generate one or more control commands to cause one or more operations to be performed by the monitored system 204. In these or other embodiments, the control commands that may be determined based on the error classification 218 may be described and/or illustrated further in the present disclosure, such as, for example, with respect to FIG. 1.

Modifications, additions, or omissions may be made to FIG. 2 without departing from the scope of the present disclosure. For example, the number of errors 206 may vary. Additionally or alternatively, the monitored system 204 may represent one or more systems and/or machines. Further, the number of modules performing operations corresponding to the error classification module 210 may vary. In some embodiments, the error handling system 202 may correspond to one or more other systems and/or modules to which the one or more errors 206 may correspond.

FIG. 3 illustrates an example computing system 300 where one or more errors may be detected and/or classified, in accordance with one or more embodiments of the present disclosure. In some embodiments, the computing system 300 may include one or more systems, modules, virtual machines, etc. where one or more errors may be detected. Further, the example computing system 300 may include one or more error handling systems 302 that may be configured to classify one or more errors as corresponding to one or more of a safety process, a non-safety process, a safety module, and a non-safety module. In these or other embodiments, the one or more error handling systems 302 may be the same as and/or analogous to the error handling system 102 and/or the error handling system 202 described and illustrated in the present disclosure, such as, for example, with respect to FIGS. 1 and 2.

In some embodiments, the virtual machines 304 may be configured to perform one or more operations corresponding to the computing system 300. In some embodiments, the operations performed using the virtual machines 304 may correspond to one or more categories of performance associated with the computing system 300. In some embodiments, each of the virtual machines 304 may correspond to a different category of performance associated with the computing system 300.

For example, the virtual machines 304 may include Bluetooth virtual machines, WiFi virtual machines, perception virtual machines, display virtual machines, trajectory virtual machines, and/or any other virtual machines that may be configured to direct or otherwise correspond to one or more categories of performance corresponding to the computing system 300 and/or one or more other associated systems.

For example, the virtual machine 304A may be a Bluetooth virtual machine that may correspond to one or more Bluetooth operations associated with the computing system 300. Continuing the example, the Bluetooth virtual machine may be configured to direct, affect, or otherwise control one or more Bluetooth operations corresponding to the computing system 300 and/or one or more other systems associated with the computing system 300. The Bluetooth operations may include connecting to one or more devices, receiving direction via Bluetooth, remotely controlling one or more systems corresponding to the computing system 300, etc. For example, in the context of the computing system 300 being used in connection with one or more ego-machines (e.g., the ego-machine 500 described further such as, for example, with respect to FIG. 5), the computing system 300 may include a Bluetooth virtual machine that may be configured to allow one or more remote devices to summon and/or direct the one or more ego-machines associated with the computing system 300.

In some embodiments, the virtual machines 304 may include one or more corresponding memory management units (MMU) 310. In some embodiments, the virtual machine 304A may include MMU 310A, the virtual machine 304B may include MMU 310B, and the virtual machine 304C may include an MMU 310C. In some embodiments, the MMUs 310 may be configured to perform one or more operations associated with managing memory access corresponding to the computing system 300 and/or one or more corresponding virtual machines 304 associated with the computing system 300. In some embodiments, the MMUs 310 may be configured to translate one or more virtual memory addresses into one or more corresponding physical memory addresses. Further, the MMUs 310 may be configured to detect which parts of memory may be used and which parts of memory corresponding to the computing system 300 may be free or useable corresponding to the computing system 300.

In some embodiments, the MMUs 310 may be configured to detect one or more errors corresponding to the computing system 300. For example, one or more errors may include one or more programs accessing one or more incorrect memory locations, and the MMUs 310 may be configured to detect that one or more incorrect memory locations may have been accessed. In these or other embodiments, the one or more errors that may be detected using the MMUs 310, may include one or more errors that may be described and/or illustrated further in the present disclosure, such as, for example, with respect to one or more errors 106, and/or the one or more errors 206 described, for example, with respect to FIGS. 1 and 2.

In some embodiments, the virtual machines 304 may further include one or more corresponding operating systems 306. In some embodiments, the virtual machine 304A may correspond to an operating system 306A, the virtual machine 304B may correspond to an operating system 306B, and the virtual machine 304C may correspond to an operating system 306C (collectively the operating systems 306). In some embodiments, the operating systems 306 may be configured to perform one or more operations corresponding to the computing system 300 including, for example, system management, resource allocation, running one or more tasks corresponding to the computing system 300, the virtual machines 304, the MMUs 310, etc. In some embodiments, the operating systems 306 may be configured to cause one or more operations that may change, stop, start, pause, and/or otherwise affect one or more processes associated with the virtual machines 304 corresponding to the operating systems 306.

In some embodiments, the hypervisor 308 may be configured to perform one or more operations that may create, direct, stop, pause, and/or otherwise affect the virtual machines 304. Further, in some embodiments, the hypervisor 308 may perform one or more operations that may be configured to virtualize one or more portions of the computing system 300, for example, the virtual machines 304, processor 312, etc.

In some embodiments, the processor 312 may be configured to perform one or more operations corresponding to the computing system 300. For example, the processor 312 may be configured to execute instructions of one or more programs, logic, input/output operations corresponding to the computing system 300. In some embodiments, the processor 312 may include one or more of a microprocessor, a central processing unit (CPU), an embedded processor, and/or any other processing unit that may be configured to perform one or more operations corresponding to the computing unit 300. Additionally or alternatively, the processor 312 may include one or more portions of a processor—e.g., a functional safety island, a trusted execution environment, etc.

In some embodiments, the processor 312 may be configured to direct and/or cause one or more operations to be performed using the virtual machines 304, the MMUs 310, the operating systems 306, the hypervisor 308 and/or the error handling systems 302 that may be included in one or more portions of the computing system 300.

In some embodiments, the processor 312 may be configured to determine and/or generate one or more control commands that may cause one or more operations to be performed that may correspond to the computing system 300. In these or other embodiments, the control commands that may be determined and/or generated using the processor 312 may include the control commands 114 described and/or illustrated further in the present disclosure, such as, for example, with respect to FIG. 1. In some embodiments, the processor 312 may be configured to stop, pause, start, and/or otherwise affect one or more of the hypervisor 308, the virtual machines 304, and/or one or more processes corresponding to the computing system 300.

In some embodiments, the error handling systems 302 may be configured to determine whether one or more errors that may be detected corresponding to the one or more MMUs 310 may correspond to one or more of a safety process, non-safety process, safety module, and/or non-safety module. In some embodiments, the classifications of one or more of a safety process, non-safety process, safety module, and/or non-safety module may be the same as and/or analogous to the safety process 120, the safety process 220, the non-safety process 122, the non-safety process 222, the safety module 124, the safety module 224, the non-safety module 126, and/or the non-safety module 226 described and/or illustrated further in the present disclosure, such as, for example, with respect to FIGS. 1 and 2.

In some embodiments, the error handling systems 302 may correspond to one or more portions of the computing system 300. In some embodiments, an error handling system 302 may correspond to the computing system 300 as a whole. Additionally or alternatively, an error handling system 302 may correspond to two or more elements within the computing system 300. Additionally or alternatively, an error handling system 302 may correspond to a particular element within the computing system 300. For example, in the illustrated example of FIG. 3, the operating systems 306A, 306B, and 306C may each include a corresponding error handling systems 302A, 302B, and 302C. Further, the hypervisor 308 may include a corresponding error handling system 302D. Additionally or alternatively, the processor 312 may include an error handling system 302E.

Additionally or alternatively, while the error handling systems 302 may be illustrated as individual blocks, each of the error handling systems 302 may represent multiple error handling systems 302. Further, each of the error handling systems 302 that correspond to a different element in FIG. 3 may be different from one or more of the error handling systems 302 corresponding to one of the other elements in FIG. 3.

In some embodiments, the error handling systems 302A, 302B, and 302C corresponding to respective operating systems 306 may be configured to classify the one or more detected errors as corresponding to one or more of a safety process or a non-safety process of their corresponding operating systems 306. Additionally or alternatively the classification may be made locally, that is, local to processes included in, or corresponding to, the one or more respective virtual machines 304. For example, the error handling system 302 corresponding to the operating system 306A may be configured to classify whether one or more errors detected using the MMU 310A may correspond to safety processes or non-safety processes that may be performed corresponding to the virtual machine 304A.

In some embodiments, the determination as to whether the one or more detected errors may correspond to a non-safety process, or a safety process may be based on one or more pre-loaded and/or predeterminations regarding the one or more processes corresponding to the one or more errors. For example, in the context of the computing system 300 being used in one or more ego-machines, it may be determined that one or more processes corresponding to generating driving information that may be presented to a user and/or driver of the ego-machine via one or more displays (e.g., speed, temperature, fuel level, etc.) may be one or more safety processes. As such, continuing the example, one or more errors corresponding to processes associated with generating driving information may be considered errors corresponding to a safety process.

In some embodiments, in response to the classification by the error handling system 302 corresponding to the one or more operating systems 306 that one or more detected errors may correspond to one or more safety processes, the operating system 306 may direct the corresponding virtual machine 304 to stop or pause the one or more processes. Additionally or alternatively, the operating system 306A and/or the error handling system 302 corresponding to the operating system 306A may be configured to send information including whether one or more processes may have been stopped and/or paused to the processor 312.

For example, continuing the example of the computing system 300 corresponding to an ego-machine, the MMU 310A may detect an error corresponding to one or more processes associated with generating driving information. In response to the one or more processes being designated as one or more safety processes the detected error may be classified as corresponding to one or more safety processes (e.g., by the error handling system 302A). Further continuing the example, the operating system 306A may be configured to stop and/or pause the one or more processes associated with generating driving information corresponding to the detected error. The operating system 306A and/or the corresponding error handling system 302A may send information to the processor 312 including, for example, that one or more processes may have been stopped and/or paused.

In some embodiments, the error handling system 302D corresponding to the hypervisor 308 may be configured to determine whether the one or more errors that may be detected using the MMUs 310 may correspond to one or more of a safety virtual machine, or a non-safety virtual machine. In some embodiments, because the virtual machines 304 are examples of subsets of one or more modules, the determination that the virtual machines 304 may be safety virtual machines or non-safety virtual machines may be the same as a determination that one or more modules may be safety modules or non-safety modules as described and/or illustrated further in the present disclosure, such as, for example, with respect to FIGS. 1 and 2.

In some embodiments, the determination as to whether the one or more detected errors may correspond to a non-safety virtual machine, or a safety virtual machine may be based on one or more pre-loaded and/or predeterminations regarding the one or more processes corresponding to the one or more errors. For example, in the context of the computing system 300 being used in one or more ego-machines, it may be determined that one or more WiFi virtual machines that may be configured to connect and share information with one or more other ego-machines may be determined to be a safety virtual machine. As such, continuing the example, one or more errors corresponding to the WiFi virtual machine may be considered errors corresponding to a safety virtual machine.

In some embodiments, in response to the classification by the error handling system 302D that one or more detected errors may correspond to a safety virtual machine, the hypervisor 308 (e.g., via the error handling system 302D) may direct the corresponding virtual machine 304 to stop or pause. Additionally or alternatively, in response to the classification that the detected error(s) correspond to a safety virtual machine, the hypervisor 308 (e.g., via the error handling system 302D) may inject a failure, or an error configured to fail and/or stop the one or more virtual machines 304. In some embodiments, the hypervisor 308 and/or the error handling system 302D may be configured to send information to the processor 312. In some embodiments, the information may include, for example, whether one or more virtual machines 304 may have been stopped and/or paused using the hypervisor 308 (e.g., via the error handling system 302D).

For example, continuing the example of the computing system 300 corresponding to an ego-machine, the MMU 310A may detect an error corresponding to a WiFi virtual machine (e.g., virtual machine 304A) associated with WiFi and/or connecting with one or more other ego-machines. In response to the WiFi virtual machine being designated as a safety virtual machine, the detected error may be classified as corresponding to a safety virtual machine. Further continuing the example, the hypervisor 308 (e.g., via the error handling system 302D) may be configured to stop and/or pause the WiFi virtual machine corresponding to the detected error. The hypervisor 308 and/or the error handling system 302D may send information to the processor 312 including, for example, that the WiFi virtual machine may have been stopped and/or paused.

In some embodiments, the error handling system 302E corresponding to the processor 312 may be configured to determine whether one or more detected errors may correspond to a safety process, a non-safety process, a safety virtual machine, or a non-safety virtual machine. In some embodiments, the processor 312 (e.g., via the error handling system 302E) may be configured to classify one or more errors globally, that is, determining whether one or more errors may affect one or more safety processes and/or safety modules even when the one or more errors may not be included in the one or more safety processes and/or safety modules.

Further, the processor 312 and/or the error handling system 302E may be configured to receive information from the one or more operating systems 306, the hypervisor 308, and/or the error handling systems 302. The information may include, for example, whether one or more processes and/or virtual machines 304 may have been stopped and/or paused based on the one or more detected errors. In some embodiments, the processor 312 (e.g., via the error handling system 302E) may determine one or more operations that may cause one or more processes and/or virtual machines 304 to stop and/or pause based on the one or more detected errors. In some embodiments, the processor 312 (e.g., via the error handling system 302E) may generate one or more control commands to stop one or more processes, virtual machines 304, the computing system 300, and/or one or more systems associated with the computing system 300.

In some embodiments, the processor 312 (e.g., via the error handling system 302E) may be configured to make one or more global determinations associated with the detected errors. The processor 312 may make global determinations in response to the processor 312 having access to information corresponding to the computing system 300 as a whole including, for example, the virtual machines 304 and/or one or more processes corresponding to the virtual machines 304, etc. In some embodiments, the determinations may be made dynamically based on data associated with an environment corresponding to the computing system 300 and/or associated systems—e.g., using situational data 216 described, for example, with respect to FIG. 2.

For example, in the context of the computing system 300 corresponding to an ego-machine, the memory management unit 310A may detect an error that may correspond to a highway pilot process that may be configured to assist a driver in maintaining a lane while on a highway. It may be determined, for example, using the operating system 306A, that the error may not correspond to a safety process. Further, the detected error and the corresponding process may be included in the perception virtual machine (e.g., virtual machine 304A).

Continuing the example, it may be determined that the perception virtual machine may be a safety virtual machine and, as a result, the hypervisor 308 and/or the error handling system 302D may determine that the detected error may correspond to a safety virtual machine. Further, the hypervisor 308 (e.g., via the error handling system 302D) may stop and/or pause operations associated with the perception virtual machine. Further continuing the example, the processor 312 and/or the error handling system 302E may determine that, while the detected error corresponds to a safety virtual machine, namely the perception virtual machine, the highway pilot process may be stopped without affecting other functionalities corresponding to the perception module (e.g., lane assist, parking assist, etc.). The processor 312 (e.g., via the error handling system 302E) may cause the highway assist process to stop until the detected error is fixed while allowing one or more remaining processes corresponding to the perception virtual machine to continue functioning.

Modifications, additions, or omissions may be made to FIG. 3 without departing from the scope of the present disclosure. For example, the number of virtual machines 304, operating systems 306, MMUs 310, error handling systems 302, hypervisors 308, and/or CPUs processor may vary. Additionally or alternatively, the computing system 300 may represent one or more systems and/or machines. In some embodiments, the number of errors that may be detected corresponding to the computing system 300 and/or one or more systems corresponding to the computing system 300 may vary. In some embodiments, reference to the processor 312 may include multiple processing units that may perform one or more operations—e.g., one or more multiprocessing systems, symmetric processing systems, parallel processing systems, etc.

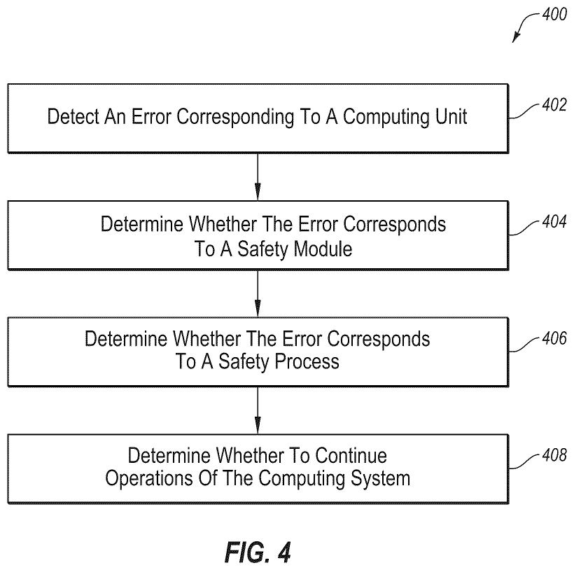

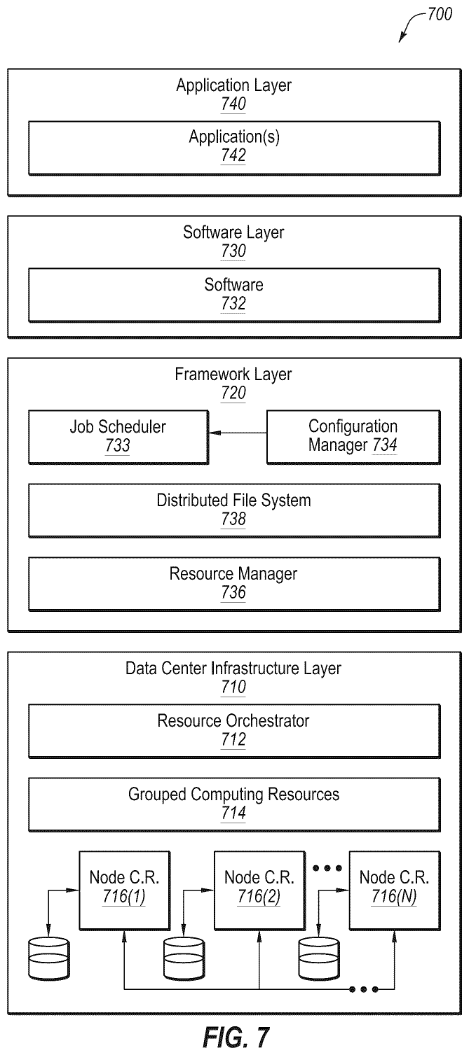

FIG. 4 is a flow diagram showing a method 400 for error handling, in accordance with one or more embodiments of the present disclosure. One or more operations of the method 400 may be performed by any suitable system, apparatus, or device such as, for example the error handling system 102, the monitored system 104, the error detection module 108, the error classification module 110, and/or the control module 112 of FIG. 1, the error handling system 202, and/or the error classification module 202 of FIG. 2, the computing system 300, the error handling system 302, the virtual machines 304, the memory management units 310, the operating systems 306, the hypervisor 308, and/or the processor 312 of FIG. 3, the autonomous vehicle system(s) described with respect to FIGS. 5A-5D, computing device(s) described with respect to FIG. 6, and/or the data system(s) described with respect to FIG. 7 in the present disclosure.

The method 400 may include one or more blocks 402, 404, 406, and 408. Although illustrated with discrete blocks, the operations associated with one or more of the blocks of the method 400 may be divided into additional blocks, combined into fewer blocks, or eliminated, depending on the particular implementation.

In some embodiments, the method 400 may include block 402. At block 402, an error may be detected. In some embodiments, the detected error may correspond to a monitored system. In some embodiments, the detected error may be detected using one or more memory management units that may correspond to the monitored system. In some embodiments, the monitored system may include one or more modules. In some embodiments, the one or more embodiments included in the monitored system may include one or more virtual machines that may correspond to the monitored system.

At block 404, it may be determined whether the detected error may correspond to a safety module (e.g., the safety module 124 and/or the safety module 224 described, for example, with respect to FIGS. 1 and 2) associated with the monitored system. In some embodiments, it may be determined that the safety module associated with the monitored system may have one or more operations that may be deemed to affect safety. Additionally or alternatively, in some embodiments, the determination may include one or more considerations described in the present disclosure, such as with respect to FIGS. 1 and 2.

At block 406, it may be determined whether the error may correspond to a safety process (e.g., a safety process 120 and/or safety process 220 described, for example, with respect to FIGS. 1 and 2) that may be associated with the monitored system. In some embodiments, the safety process may include one or more operations that may be deemed to affect safety. Additionally or alternatively, in some embodiments, the determination may include one or more considerations described in the present disclosure, such as with respect to FIGS. 1 and 2.

At block 408, it may be determined whether to continue one or more operations of the monitored system (e.g., the monitored system 104 and/or the monitored system 204 described, for example, with respect to FIGS. 1 and 2). In some embodiments, it may be determined whether to continue one or more operations based on whether the error may correspond to a safety module associated with the monitored system that may have one or more operations that are deemed to affect safety. Additionally or alternatively, it may be determined to continue one or more operations based on whether the detected error may correspond to a safety process that may be associated with the monitored system where the monitored system may include one or more operations that are deemed to affect safety. Additionally or alternatively, in some embodiments, the determination may include one or more considerations described in the present disclosure, such as with respect to FIGS. 1 and 2.

Modifications, additions, or omissions may be made to one or more operations included in the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (BIU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100 m, with an accuracy of 2 cm-3 cm, and with support for a 100 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
detecting an error corresponding to a monitored system;
determining one or more of:
whether the error corresponds to a safety module associated with the monitored system, having one or more operations that are deemed to affect safety; or
whether the error corresponds to a safety process associated with the monitored system including one or more operations that are deemed to affect safety; and
determining one or more operations of the monitored system based at least on whether the error corresponds to a safety module associated with the monitored system having one or more operations that are deemed to affect safety or whether the error corresponds to a safety process associated with the monitored system including one or more operations that are deemed to affect safety.

2. The method of claim 1, wherein the determining whether the error corresponds to a safety module is based at least on data generated using one or more sensors corresponding to the monitored system.

3. The method of claim 1, wherein the monitored system includes one or more modules, the one or more modules including one or more virtual machines corresponding to the monitored system.

4. The method of claim 1, wherein determining whether the error corresponds to a safety module associated with the monitored system is based at least on whether the error affects one or more of navigation, decision making, or perception of one or more systems corresponding to the monitored system.

5. The method of claim 1, wherein the determining whether the error corresponds to a safety process is based at least on whether the error affects one or more measurable safety metrics corresponding to an individual, the monitored system, or one or more systems associated with the monitored system with respect to one to more predetermined thresholds.

6. The method of claim 5, wherein the one or more predetermined thresholds are based at least on one or more of: an amount of economic loss or an amount of damage to the monitored system.

7. The method of claim 1, wherein the error is detected using one or more memory management units corresponding to the monitored system.

8. The method of claim 1, wherein, when the error is determined to not correspond to a safety process or a safety module, the error is reported for correction while the monitored system continues performing one or more operations.

9. The method of claim 1, wherein the monitored system is directed to perform a low-risk maneuver to stop the monitored system in response to determining the error corresponds to a safety module associated with the monitored system or that the error corresponds to a safety process associated with the monitored system.

10. A system comprising:
one or more processing units to perform operations comprising:
detecting an error corresponding to a computing unit;
determining one or more of:
whether the error corresponds to a safety module associated with the computing unit, having one or more operations that are deemed to affect safety; or
whether the error corresponds to a safety process associated with the computing unit including one or more operations that are deemed to affect safety; and
determining one or more operations of the computing unit based at least on whether the error corresponds to a safety module associated with the computing unit having one or more operations that are deemed to affect safety or whether the error corresponds to a safety process associated with the computing unit including one or more operations that are deemed to affect safety.

11. The system of claim 10, wherein the determining whether the error corresponds to a safety module is based at least on data generated using one or more sensors corresponding to the computing unit.

12. The system of claim 10, wherein the computing unit includes one or more modules, the one or more modules including one or more virtual machines corresponding to the computing unit.

13. The system of claim 10, wherein determining whether the error corresponds to a safety module associated with the computing unit is based at least on whether the error affects one or more of navigation, decision making, or perception of one or more systems corresponding to the computing unit.

14. The system of claim 10, wherein the determining whether the error corresponds to a safety process is based at least on whether the error affects one or more measurable safety metrics corresponding to an individual, the computing unit, or one or more systems associated with the computing unit with respect to one or more predetermined thresholds.

15. The system of claim 10, wherein the system is comprised in at least one of: a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

16. A processor comprising processing circuitry to perform operations, the operations comprising:
detecting an error corresponding to a computing unit;
determining one or more of:
whether the error corresponds to a safety module associated with the computing unit, having one or more operations that are deemed to affect safety; or
whether the error corresponds to a safety process associated with the computing unit including one or more operations that are deemed to affect safety; and
determining one or more operations of the computing unit based at least on whether the error corresponds to a safety module associated with the computing unit having one or more operations that are deemed to affect safety or whether the error corresponds to a safety process associated with the computing unit including one or more operations that are deemed to affect safety.

17. The processor of claim 16, wherein the determining whether the error corresponds to a safety process is based at least on whether the error affects one or more measurable safety metrics corresponding to an individual, the computing unit, or one or more systems associated with the computing unit with respect to one or more predetermined thresholds.

18. The processor of claim 16, wherein the error is detected using one or more memory management units corresponding to the computing unit.

19. The processor of claim 16, wherein, when the error is determined to not correspond to a safety process or a safety module, the error is reported for correction while the computing unit continues performing one or more operations.

20. The processor of claim 16, wherein the computing unit is directed to perform a low-risk maneuver to stop the computing unit in response to determining the error corresponds to a safety module associated with the computing unit or that the error corresponds to a safety process associated with the computing unit.
